(19) United States
(12) Patent Application Publication
(10) Pub. No.: US 2006/0038390 A1
(43) Pub. Date: Feb. 23, 2006

(54) Knee bolster mounting structure for a glove box

(75) Inventor: Joung-Hwan Cho, Bupyeong-gu (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/201,317

(22) Filed: Aug. 11, 2005

(30) Foreign Application Priority Data
Aug. 17, 2004 (KR) 2004-64751

(51) Int. Cl. B60R 21/045

(52) U.S. Cl. 280/752

(57) ABSTRACT

A knee bolster mounting structure for a glove box having a housing having a predetermined space defined therein, a cover coupled to a front side of the housing to form an outer appearance of the glove box, and a knee bolster interposed between the housing and the cover to absorb impact in case of collision includes a plurality of fuse ribs protruded from front and rear surfaces of the knee bolster and fused thereto by vibration fusion, respectively, and round portions formed on each end of the fuse ribs.

### RELATED APPLICATIONS

The present disclosure relates to subject matter contained in Korean Application No. 10-2004-0064751, filed on Aug. 17, 2004, which is herein expressly incorporated by reference its entirety.

### BACKGROUND OF THE INVENTION

1. Field of the Invention

The present invention relates to a knee bolster integral to a glove box, and more particularly, to a knee bolster mounting structure for a glove box, which has an enhanced structure of fuse ribs in the knee bolster so as to enable the plurality of fuse ribs to contact the housing and a cover while maintaining a uniform contact area between the fuse ribs and the housing and between the fuse ribs and the cover, thereby allowing uniform assembly there between.

2. Description of the Related Art

A glove box used for a vehicle is a space defined in a right lower end of an instrument panel 10, as shown in FIG. 1, to contain small articles and the like, and a knee bolster 40 is a reinforcing panel mounted on the instrument panel 10 for the purpose of preventing a passenger from injuring their knees while restricting movement of the passenger in the event of a vehicle collision. Generally, the knee bolster is integrated to the glove box in order to satisfy spatial restrictions of the instrument panel. FIG. 2 is an exploded perspective view illustrating the conventional knee bolster integrating glove box.

Referring to FIG. 2, in the conventional knee bolster integrating glove box, the knee bolster 40 is interposed between a hosing 20 and a cover 30. Meanwhile, since the knee bolster 40 is fixed to the cover 30 by means of screws, fracture of the cover 30 of the glove box in the event of a vehicle collision. causes the screws fastening the knee bolster 40 to the cover 30 to be exposed, thereby providing the possibility of injury to the passenger. In order to solve such a problem, the knee bolster 40 is fused to the housing 20 and the cover 30 by means of vibration fusion. That is, as shown in FIG. 3, the knee bolster 40 has a cross-section of a continuously bent serpentine shape so as to absorb any collision impact, and a plurality of fuse ribs 42 formed on both the front and rear surfaces of the knee bolster 40 such that the fuse ribs 42 formed on the rear surface of the knee bolster 40 contact, and are fused to the housing 20, while the fuse ribs 42 formed on the front surface of the knee bolster 40 contact, and are fused to the cover 30 by the vibration fusion.

In this way, the knee bolster integrating glove box, which comprises the housing 20, the cover 30, and the knee bolster 40 interposed between the housing 20 and the cover 30, can be provided without any screw fastening.

However, since each of the fuse ribs 42 has a rectangular end inclined at a predetermined angle, as shown in FIG. 3, in the conventional knee bolster integrating glove box, distances between the housing 20 and the cover 30 are different from each other at respective locations thereof according to features of the housing 20 and the cover 30. As a result, the fuse ribs 42 have different contact areas from each other at the respective ends of the fuse ribs 42 to the housing 20 and the cover 30, thereby causing the respective fuse ribs 42 to be non-uniformly fused to the housing 20 and the cover 30. For example, for some fuse ribs 42, a whitening phenomenon occurs on an outer surface of the glove box due to excessive fusion of the fuse ribs 42, and for other fuse ribs 42, the ends of the fuse ribs 42 are minimally fused to the glove box, and provide insufficient bonding strength, resulting in non-uniform fusion between the fuse ribs and the glove box.

### SUMMARY OF THE INVENTION

The present invention has been made to solve the above problems, and it is an object of the present invention to provide a knee bolster mounting structure for a glove box, designed to have a round portion formed on each end of a plurality of fuse ribs of the knee bolster so as to allow the fuse ribs to have a uniform contact area at the ends to a housing and a cover of the glove box, irrespective of a direction in which the fuse ribs contact the housing and the cover, so that the knee bolster is uniformly joined to the housing and the cover of the glove box, thereby preventing any whitening phenomenon.

In accordance with an aspect of the present invention, the above and other objects can be accomplished by the provision of a knee bolster mounting structure for a glove box, comprising: a housing having a predetermined space defined therein, and hinged at one end thereof to the glove box in order to hinge between an inner side and an outer side of the glove box about the end fixed to the glove box; a cover coupled to a front side of the housing to form the outer appearance of the glove box, and having a locking device equipped to one side of the cover in order to open and close the housing; a knee bolster interposed between the housing and the cover to absorb impact in case of any collision; a plurality of fuse ribs protruding from front and rear surfaces of the knee bolster to be fused thereto by vibration fusion, respectively; and round portions formed on each end of the fuse ribs so as to enable the fuse ribs to have a uniform contact area to the housing and the cover, irrespective of the angle at which the fuse ribs contact the housing and the cover, thereby allowing uniform fusion between the fuse ribs and the housing and between the fuse ribs and the cover.

### BRIEF DESCRIPTION OF THE DRAWINGS

The foregoing and other objects and features of the present invention will be more clearly understood from the following detailed description taken in conjunction with the accompanying drawings, in which:

FIG. 1 is a perspective view illustrating the interior of a general vehicle;

FIG. 2 is an exploded perspective view illustrating a conventional knee bolster mounting structure for a glove box;

FIG. 3 is a cross-sectional view illustrating the conventional knee bolster mounting structure for the glove box; and

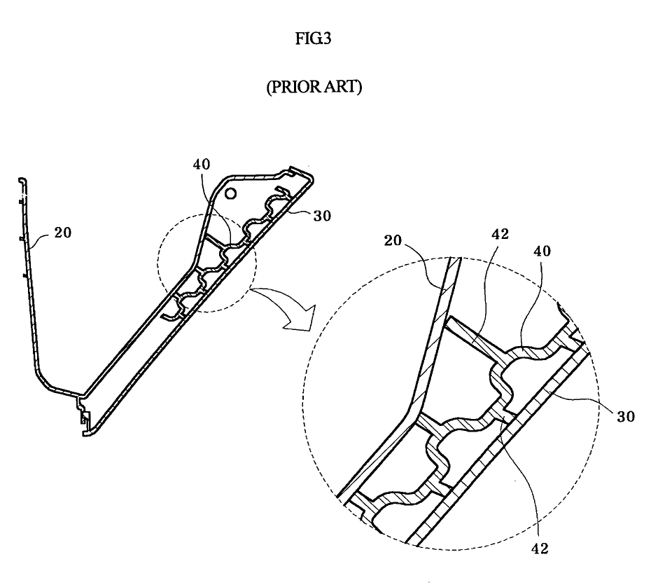

FIG. 4 is a cross-sectional view illustrating a knee bolster mounting structure for a glove box according to the present invention.

### DESCRIPTION OF THE PREFERRED EMBODIMENTS

Preferred embodiments will now be described in detail with reference to the accompanying drawings. Like components having similar functions to those of the conventional knee bolster mounting structure for the glove box will be denoted by like reference numerals of the conventional knee bolster mounting structure for the glove box.

As shown in the drawings, a knee bolster integrating glove box in accordance with the present invention comprises a housing 20, which has a predetermined space defined therein and is hinged at a lower end thereof to an instrument panel, a cover 30, which is coupled to the front side of the housing 20 to form the outer appearance of the glove box and has a locking device equipped to one side of a front surface of the cover 30, and a knee bolster 40, which is interposed between the housing 20 and the cover 30 to absorb any impact, which can be applied to a passenger by the cover 30 in case of any collision.

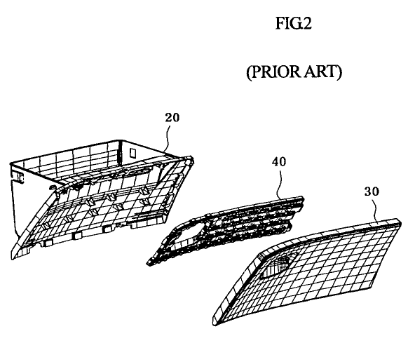

Here, the housing 20 has a predetermined space, which is opened at an upper portion thereof while being narrowed downwardly, as shown in FIG. 2, and is hinged at the lower end of the housing 20 to the instrument panel, such that the housing can be hinged towards a space defined in the instrument panel or towards the outside of the instrument panel, thereby constituting the glove box.

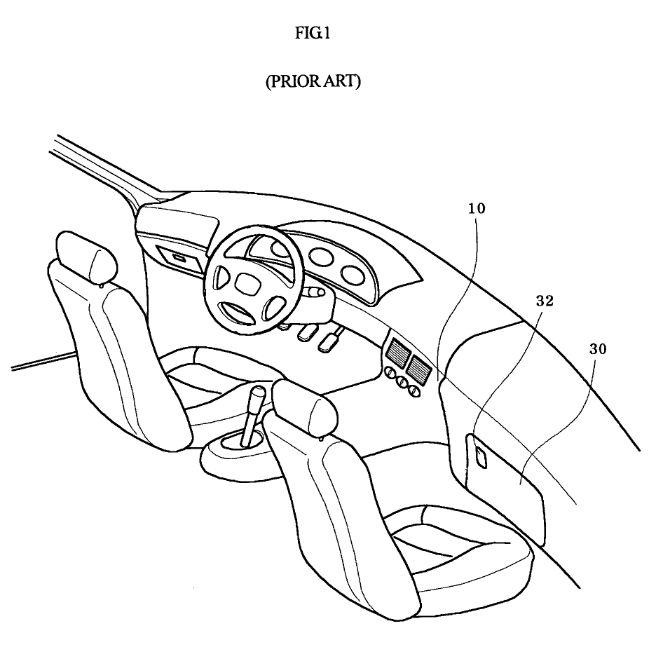

The cover 30 has the locking device 32 equipped to the one side of the front surface thereof, as shown in FIG. 1, with which the cover 30 can be fixed to or separated from the instrument panel by the user's manipulation. Accordingly, when the cover 30 is separated from the instrument panel by the user, the housing can be rotated towards the outside of the instrument panel, thereby allowing the glove box to be opened. When the cover 30 is pushed into the inside of the instrument panel by the user, the housing 20 is rotated and inserted into the inner space of the instrument panel, and in this state, the locking device 32 of the cover 30 is fastened to the instrument panel, thereby closing the glove box.

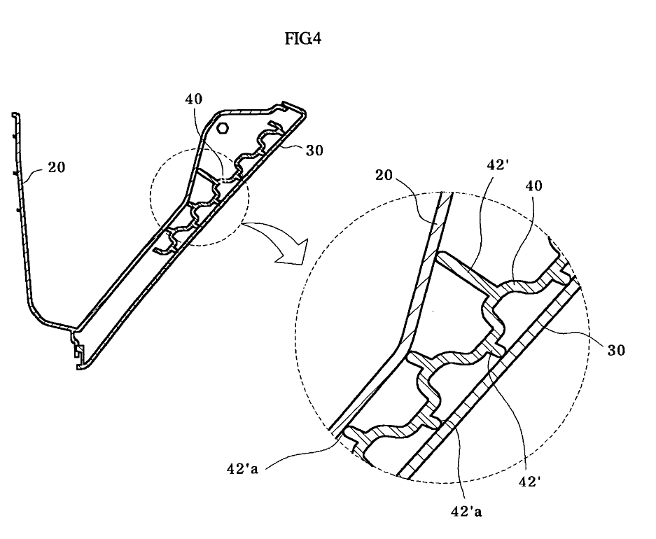

The knee bolster 40 is made of a synthetic resin having elasticity, which can maximize the buffering effect, and has a continuous serpentine cross-section, as shown in FIG. 4, in order to absorb impact upon collision.

Additionally, the knee bolster 40 has a plurality of fuse ribs 42 protruded from the front and rear surfaces of the knee bolster 40 to contact the housing 20 and the cover 30, respectively, so that the knee bolster 40 can be joined to the housing 20 and the cover 30 by vibration fusion, instead of fastening the knee bolster 40 to the housing 20 and the cover 30 using bolts and nuts.

In the specification, the term “fusion” means that, after melting a matrix material, the matrix material is joined to a certain member in a melted state, and the fusion is thus different from general welding, which allows one material to be joined to the member by use of another material (such as a welding rod), in that the matrix material is melted and joined to the member without using the other material.

Additionally, the vibration fusion is utilized for locally meting and joining a metallic material or a plastic material, and is also utilized for spot welding, seam welding, and the like. In the case of the vibration fusion, supersonic vibration, pressure, and time can play important roles in determining good quality of a fused state. In such a vibration fusion, contact areas between fused members must be uniformly distributed on an overall surface of the fused surface in order to maximize the bonding strength. According to the present invention, since the knee bolster integrating glove box has a plurality of fuse ribs 42′, each of which has a round portion 42a formed on the end thereof, the fuse ribs 42′ can have a uniform contact area, irrespective of the direction in which the fuse ribs 42′ contact the housing 20 and the cover 30.

In order to accomplish an idealistic vibration fusion, the fused surface of the housing and the cover must vertically contact each of the fuse ribs 42. However, as shown in FIG. 4, since the housing 20 has an inwardly curved upper portion, and distances between the housing 20 and the cover 30 are not constant, it is impossible to allow the fuse ribs 42′ to vertically contact both the housing 20 and the cover 30. In such configurations of the housing 20 and the cover 30, the round portion 42a has a circular configuration, which can most closely satisfy the condition that the fuse ribs 42′ have the fused surfaces vertical to the housing 20 and the cover 30.

As a result, the whitening phenomenon caused by the excessive fusion can be prevented, and a stable joining between the knee bolster 40 and the housing 20 and between the knee bolster 40 and the cover 30 can be ensured by the uniform fusion.

As apparent from the above description, the knee bolster mounting structure for the glove box of the invention has a round portion formed on each end of the fusion ribs of the knee bolster, so that the respective fusion ribs uniformly contact the housing and the cover, thereby providing stable fusion between the knee bolster and the housing and between the knee bolster and the cover, leading to the reduction of defective products in manufacturing the glove box.

Additionally, the uniform fusion prevents the whitening phenomenon from occurring on the outer surface of the cover, thereby providing a clean appearance of the glove box. It should be understood that the embodiments and the accompanying drawings as described above have been described for illustrative purposes and the present invention is limited by the following claims. Further, those skilled in the art will appreciate that various modifications, additions and substitutions are allowed without departing from the scope and spirit of the invention as set forth in the accompanying claims.

1. A knee bolster mounting structure for a glove box, comprising:
a housing having a predetermined space defined therein, and hinged at one end thereof to the glove box in order to hinge between an inner side and an outer side of the glove box about the end fixed to the glove box;
a cover coupled to a front side of the housing to form an outer appearance of the glove box, and having a locking device equipped to one side of the cover in order to open and close the housing;
a knee bolster interposed between the housing and the cover to absorb impact in case of collision;
a plurality of fuse ribs protruded from front and rear surfaces of the knee bolster and fused thereto by vibration fusion, respectively; and
round portions formed on each end of the fuse ribs so as to enable the fuse ribs to have a uniform contact area to the housing and the cover, irrespective of the angle at which the fuse ribs contact the housing and the cover, thereby allowing uniform fusion between the fuse ribs and the housing or the cover.

2. A knee bolster mounting structure for a glove box, comprising:
a plurality of fuse ribs protruded from front and rear surfaces of a knee bolster and fused thereto by vibration fusion, respectively; and
round portions formed on each end of the fuse ribs so as to enable the fuse ribs to have a uniform contact area to a housing and a cover, irrespective of the angle at which the fuse ribs contact the housing and the cover, thereby allowing uniform fusion between the fuse ribs and the housing or the cover.
